(19) United States
(12) Patent Application Publication
(10) Pub. No.: US 2026/0249182 A1
(43) Pub. Date: Aug. 27, 2026

(54) CUSTOMIZED AUDIO SIGNAL GENERATION FOR POWER-UP PROCESS OF A GAMING SYSTEM

(71) Applicant: Sony Interactive Entertainment Inc., Tokyo (JP)

(72) Inventor: Isaiah Webb, San Mateo, CA (US)

(21) Appl. No.: 19/065,974

(22) Filed: Feb. 27, 2025

(51) Int. Cl. A63F 13/54; H04R 3/00

(52) U.S. Cl. CPC A63F 13/54; H04R 3/00

(57) ABSTRACT

Methods, systems, and apparatus, including computer programs encoded on computer storage media, for generating one or more customized audio signals for a gaming system. One of the methods includes obtaining contextual data associated with a power-up process of the gaming system, the contextual data including at least one of: time information or location information associated with the power-up process of the gaming system, generating, using a machine learning model, the one or more customized audio signals, the machine learning model trained to generate the one or more customized audio signals in accordance with one or more components of the contextual data, and providing the one or more customized audio signals to at least one acoustic transducer associated with the gaming system to be outputted through the at least one acoustic transducer.

### BACKGROUND

Electronic gaming systems incorporate one or more devices that allow users to engage with media in interactive and versatile ways. That is, gaming systems serve as multifunctional platforms for multiple use cases associated with different types of media. For example, users can interact with a gaming system to play video games, to stream media, or to communicate with other users. As a result of this broad level of use, gaming systems allow for customization of a user's interaction with media based on individual information and preferences.

### SUMMARY

This specification describes technologies for generating one or more customized audio signals for a gaming system. A gaming system is a system configured to output media to a user using hardware components and software components. For example, a gaming system can include a gaming console, a user device, or a combination thereof to output media to the user. The gaming console can be a particular dedicated device configured to load and store media.

In some cases, during the power-up process of a gaming system, the system can output an audio signal to at least one acoustic transducer to indicate that the system is powering on. For example, the acoustic transducer can be an internal speaker of the gaming system (e.g., a speaker associated with the gaming console) or an external speaker coupled to the gaming system. In this case, the system is configured to generate one or more customized audio signals to be outputted through at least one acoustic transducer.

In general, one innovative aspect of the subject matter described in this specification can be embodied in methods that include the actions of obtaining contextual data associated with the power-up process. The contextual data can include at least time information, such as a current time of day or a current time of year, or location information, such as a current location, current season, or current weather. The system can then generate the one or more customized audio signals using a machine learning model, where the machine learning model is trained to generate the one or more customized audio signals in accordance with one or more components of the contextual data. The system can then provide the customized audio signal to the at least one acoustic transducer.

Other embodiments of this aspect include corresponding computer systems, apparatus, and computer programs recorded on one or more non-transitory computer storage devices, each configured to perform the actions of the methods.

The foregoing and other embodiments can each optionally include one or more of the following features, alone or in combination. For example, one embodiment includes all the following features in combination.

In some implementations, the system can store one or more customized audio signals on a storage device associated with the gaming system such that the one or more customized audio signals are outputted through the at least one acoustic transducer during a subsequent power-up process.

In some implementations, the at least one acoustic transducer is disposed on a gaming console associated with the gaming system.

In some implementations, the at least one acoustic transducer is external to a gaming console associated with the gaming system.

In some implementations, outputting the one or more customized audio signals is facilitated by an operation system of the gaming system.

In some implementations, generating, using the machine learning model, the one or more customized signals includes: receiving feedback data associated with the one or more customized audio signals, and updating at least one of the one or more customized signals based on the feedback data.

In some implementations, the time information includes a current time of day, a current time of year, or both.

In some implementations, the location information includes a current season, a current location, current weather, or a combination thereof.

In some implementations, the contextual data includes user customization information including historical user data, feedback data, user preference data, or a combination thereof.

In some implementations, the historical user data includes information associated with media previously downloaded onto a user device of the gaming system, information associated with media previously loaded onto the gaming console of the gaming system, or a combination thereof.

In some implementations, the user preference data includes a respective preferred time length of each of the one or more customized audio signals on the gaming system.

In some implementations, generating, using the machine learning model, the one or more customized audio signals includes: wrapping at least one of the one or more customized audio signals with a particular standardized audio signal prior to the at least one customized audio signals, after the at least customized audio signal, or both.

The subject matter described in this specification can be implemented in particular embodiments so as to realize one or more of the following advantages.

By generating one or more customized audio signals for a gaming system based on the power-up process of the gaming system, the technology described herein expands a gaming system's functionalities beyond those typically associated with a gaming system. That is, the described techniques allow for increased customization for a particular user of the gaming system based on contextual information, allowing for increased versatility in generating a unique audio signal (e.g., jingle) for the user at both the initial power-up stage and the boot-up stage of the power-up process. For example, the system can obtain contextual information, such as location information, time information, or information specifically about the user (e.g., user preferences, user data, or user feedback), and the system can leverage a pre-trained machine learning model to generate the customized audio signals, allowing the system to output the customized audio signals using an operating system and/or using one or more speakers or acoustic transducers external to the gaming console.

Such increase in versatility of the gaming system allows for the generation of unique, user-specific sounds during the power-up process, rather than relying on generic audio cues. This personalization not only creates a more immersive and distinctive experience. Additionally, the system can store these customized sounds for seamless and efficient reuse, further enhancing performance and user engagement.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that generates one or more customized audio signals in accordance with technology described herein.

FIG. 2 is a diagram of an example gaming system as shown in FIG. 1.

FIG. 3 is a flow diagram of an example process for generating the one or more customized audio signals by processing data.

FIG. 4 is a block diagram of a computing system that can be used in connection with computer-implemented methods described in this specification.

Like reference numbers and designations in the various drawings indicate like elements.

### DETAILED DESCRIPTION

This document describes technology that enables a gaming system to generate customized audio signals during the power-up process, thus providing for a personalized and potentially more engaging user experience. This can be achieved, for example, by leveraging various types of contextual information—such as location, time, and user preferences—and utilizing a pre-trained machine learning model to create customized audio signals played at various stages of a power-up process of the gaming system. This in turn can meaningfully affect user-interactions and user-engagement, potentially providing for more dynamic and welcoming user experiences during a power-up process as compared to playing the same sounds and jingles each time. By allowing for user-feedback on the customized audio signals generated using technology described herein, a user is provided with more control on the sounds and audio clips output by the system. Overall, the technology described herein can allow for versatile and efficient gaming systems, where personalized audio signals enhance user.

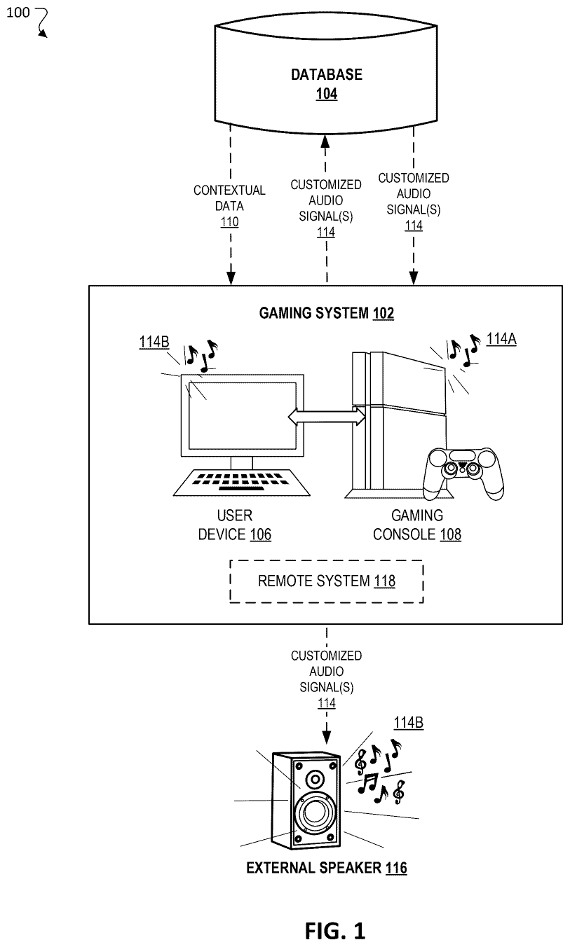

FIG. 1 is a block diagram of an example system that generates one or more customized audio signals in accordance with technology described herein in accordance with technology described herein.

The system 100 includes a gaming system 102 and a database 104. The gaming system 102 is configured to output media to a user using hardware components and software components, such as an operating system. For example, the gaming system 102 can include a user device 106, a gaming console 108, or a combination thereof to output media to the user. The gaming console 108 can be a particular dedicated device configured to load and store media. The gaming console 108 can be coupled to the user device, which can serve as a display for the media (e.g., a television, monitor, etc.). In some examples, the gaming console 108 can be coupled to external controllers that can provide input for interacting with the media. For example, a user playing a video game can load the video game on the gaming console 108, and the user can interact with the video game via the user device 106, the external controller, or both. The database 104 is configured to store data associated with the gaming system 102.

In general, the gaming system 102 can be switched on to initiate a power-up process. In some examples, a user can interact with the gaming system 102 to initiate the power-up process (e.g., pressing an “on” button on the gaming console 108, interacting with an external controller, etc.). In this case, an operating system of the gaming system 102 can receive the “on” signal, and the system can initiate the power-up process. The power-up process can include an initial power-up stage that activates the hardware components of the gaming system 102 and a boot-up stage that activates the software components of the gaming system 102.

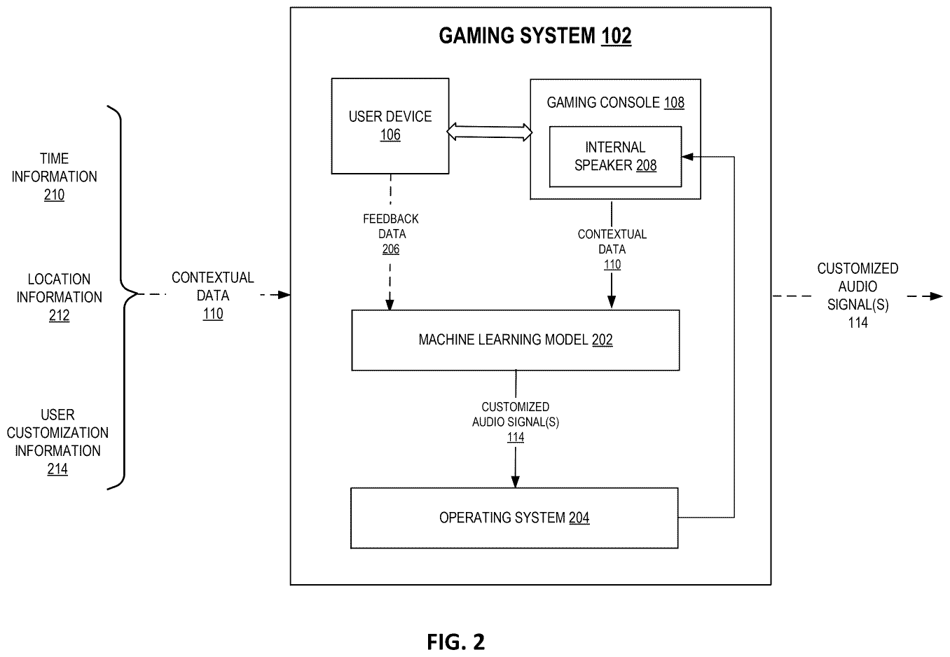

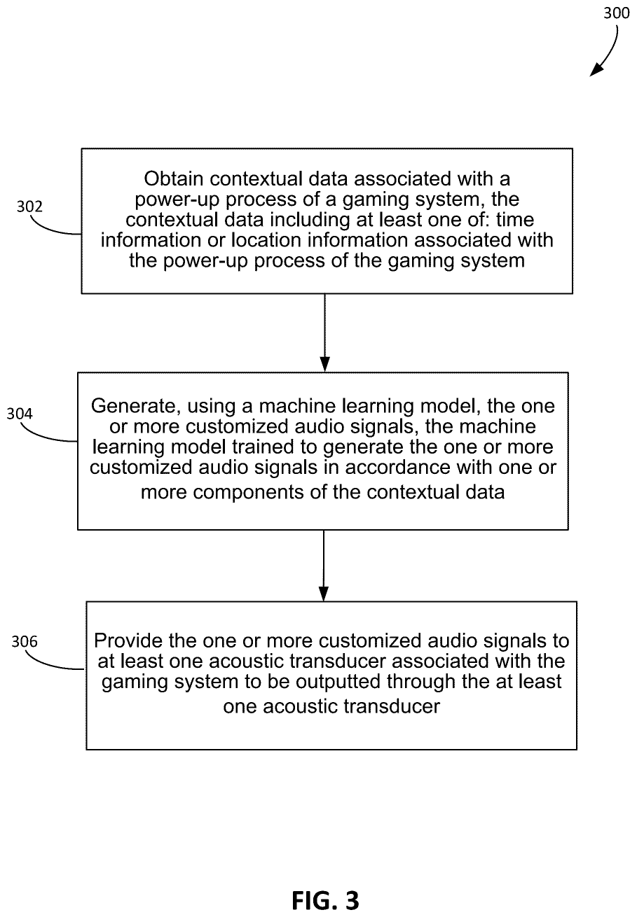

In some implementations, the gaming system 102 is configured to generate one or more customized audio signals based on contextual data 110 associated with the power-up process of the system 102. For example, the gaming system 102 can process the contextual data using a trained machine learning model to generate the customized audio signals 114, as described in further detail below with reference to FIGS. 2 and 3. In some examples, the customized signal generation method can be performed, at least in part, on a portion of the gaming system 102, such as one or more processing devices of the gaming console 108, or at a remote location (e.g., on a cloud-based distributed computing system). In some examples, the remote location can be considered as a portion of the gaming system 102.

The contextual data 110 can include time information and/or location information associated with the user. In some examples, the contextual data 110 can include user customization data 112, which represents information unique to the particular user of the gaming system 102. The user customization data 112 can include historical user data, feedback data, and/or user preference data, as described in further detail below with reference to FIGS. 2 and 3. The historical user data can include historical information associated with previous interactions with media using the gaming system.

In some examples, the gaming system 102 can generate the customized audio signals 114 for different stages of the power-up process. For example, the gaming system 102 can generate a first customized audio signal 114A for an initial power-up stage of the power-up process, while the gaming system 102 can generate a second customized audio signal 114B for a boot-up stage of the power-up process. The specification will refer to the first customized audio signal 114A and the second customized audio signal 114B in general as the customized audio signals 114. In some cases, the gaming system 102 can generate a second customized audio signal 114B using an increased amount of contextual data as compared to that used for the first customized audio signal 114A. For example, during the boot-up process, the gaming system 102 can access additional data (e.g., from the database 104), and leverage the additional data to generate the second customized audio signal 114B.

In some implementations, the customized audio signals 114 can be provided to an acoustic transducer associated with the gaming system 102. An acoustic transducer is a device that converts energy (e.g., electrical energy) into audio signals. Examples of acoustic transducers include microphones, speakers, sonar systems, and ultrasonic devices.

In some implementations, the gaming console 108 can include an internal acoustic transducer (e.g., an internal speaker) configured to output the customized audio signals 114 during the power-up process. In some implementations, the gaming system 102 can be coupled to an external speaker 116, and the gaming system 102 can provide the customized audio signals 114 to the external speaker 116, such that the external speaker 116 can output (e.g., play) the customized audio signals. For example, the external speaker 116 can be a Bluetooth speaker, a home audio speaker, a computer speaker, or a home theater speaker.

In some implementations, the gaming system 102 can generate the customized audio signals 114 based on a capability of the corresponding acoustic transducer. For example, the gaming system 102 can generate the customized audio signals 114 based on a sound quality, a connectivity, a power capability, or a combination thereof of the particular acoustic transducer. That is, based on a respective capability of a corresponding internal speaker or external speaker, the gaming system 102 can generate the audio signals 114 to be outputted at a particular volume.

In some examples, the gaming system 102 can provide the customized audio signals 114 to different acoustic transducers for different stages of the power-up process. For example, the gaming system 102 can provide a first customized audio signal 114A for an initial power-up stage to a first acoustic transducer (e.g., an internal speaker of the gaming console 108), and/or the gaming system 102 can provide the second customized audio signal 114B for the boot-up stage of the power process to a second acoustic transducer (e.g., the external speaker 116 or an acoustic transducer on the user device 106).

In some examples, the gaming system 102 is configured to access the database 104 to store data on and/or retrieve data from the database 104. For example, during a boot-up stage of the gaming system 102 using the software components, the gaming system 102 can have a greater capacity to receive and load data from the database 104 for use in generating the customized audio signals 114 in comparison to the initial power-up stage of the gaming system 102. In some implementations, the database 104 can be configured to store contextual data 110, e.g., time information, location information, historical data, user customization data, and/or a combination thereof. In some implementations, e the contextual data 110 is retrieved by the gaming system 102 from the database 104 during the boot-up stage to generate one or more customized audio signals 114. For example, the database 104 can provide historical user data including information associated with media previously downloaded onto the user device 106, information associated with media previously loaded onto the gaming console 108, or both. The gaming system 102 then uses the contextual data 110 to generate the customized audio signals 114, as described in further detail below with reference to FIG. 2.

In some implementations, a prior-generated customized audio signal can be retrieved from the database 104 and played by the gaming system 102 during the initial stage of the power-up process. Because the amount of hardware and software resources available during the initial stage of the power-up process is typically limited, generating customized audio in real-time or near-real-time can be challenging. As such, retrieving and playing a pre-generated audio clip can represent an efficient use of available resources while still providing for the functionality of playing customized audio. In some implementations, the pre-generated audio clip can be locally stored on the gaming console 108 for easy retrieval. In some implementation, the gaming system 102 can access the database 104 during the power-up process (e.g., during the initial stage of the power-up process), such that the gaming system 102 can output a customized audio signal 114 (e.g., a first customized audio signal 114A) prior to the boot-up stage of the power-up process. In some implementations, the second customized audio signal 114B that is output during the boot-up stage of the power-up process may also be retrieved—from a local storage on the gaming console 108 or the database 104—and played back through an appropriate acoustic transducer. Leveraging a previously-generated customized audio signal for subsequent processes can therefore allow for a customized experience for the user while efficiently utilizing potentially low amount of hardware and/or software resources available during the power-up process.

FIG. 2 is a block diagram of an example gaming system as shown in FIG. 1 in accordance with technology described herein. The gaming system 102 includes the user device 106 and the gaming console 108. As described above, the gaming console 108 can include an internal speaker 208 configured to output the customized audio signals 114.

The gaming system 102 further includes a machine learning model 202 and an operating system 204. The operating system 204 is a software component that interfaces with the hardware components of the gaming system 102 and the user device 106. In this case, the operating system 204 is configured to provide the customized audio signals 114 to the gaming console 108. The machine learning model 202 is trained to generate the customized audio signals 114 based on the contextual data 110. For example, the machine learning model 202 can be a generative machine learning model pre-trained to perform a particular task.

For example, the task can be an audio generation task. For example, if the input to the neural network is a text input, the output generated by the neural network may be an audio signal representing a spectrogram, a waveform, or other data defining audio of the text being spoken in the natural language. In some cases, the machine learning task is a multi-modal processing task that requires processing multi-modal data. In general, multi-modal data is a combination of two or more different types of data, e.g., two or more of audio data, image data, text data, or graph data. As one example the multi-modal data may include audio-visual data, including a combination of pixels of an image or of video and audio data representing values of a digitized audio waveform. As another example the multi-modal data may include a combination of i) text data representing text in a natural language and ii) pixels of an image or of video or audio data representing values of an audio waveform.

For example, the gaming system 102 is configured to provide contextual data 110 from the gaming console 108 to the machine learning model 202. The gaming system 102 is then configured to use the machine learning model 202 to generate the customized audio signals 114 by processing the contextual data 110. In some examples, the gaming system 102 can process a first set of components of the contextual data 110 using the pre-trained machine learning model 202 to generate a first customized audio signal 114A. The first customized audio signal 114A can be associated with the initial power-up stage of the gaming system 102. In this case, the gaming system 102 can process a second set of components of the contextual data 110 using the pre-trained machine learning model 202 to generate the second customized audio signal 114B. The second customized audio signal 114B can be associated with the boot-up stage of the gaming system 102. The second set of components can be greater than the first set of components, such that the second customized audio signal 114B is generated using a greater amount of resources than the first customized audio signal 114A, as described above.

The gaming system 102 can then provide the customized audio signals 114 to the operating system 204, and the operating system 204 can facilitate providing the customized audio signals 114 to the gaming console 108, such that the internal speaker 208 can output the customized audio signals 114 during the power-up process of the gaming system 102. In some examples, the operating system 204 can facilitate providing the customized audio signals 114 to an external speaker of the gaming system 102 (e.g., the external speaker 116).

In some examples, the gaming system 102 can receive the contextual data 110 from the database 104. The contextual data can include time information 210, location information 212, and user customization information 214. The time information 210 can include a current time of day, a current time of year, or both. The location information 212 can include a current season, a current location, current weather, or a combination thereof. The user customization information 214 can include historical user data, user preference data, feedback data, or a combination thereof.

The historical user data can include data that represents media previously downloaded onto a user device of the gaming system, information associated with media previously loaded onto the gaming console of the gaming system, or both. For example, the data can represent a genre of one or more video games or videos that a user previously played or watched on the gaming system.

The user preference data can include data that represents a respective preferred length of the customized audio signals 114 on the gaming system 102. For example, the user can interact with the user device 106 to select a period of time during which a particular audio signal will play on the gaming system. For example, the user can select for the gaming system 102 to generate a new customized audio signal periodically, such as once a month, once a season, or each time the gaming system performs the power-up process.

The feedback data 206 can include data that represents feedback from the user via the user device 106. For example, the gaming system 102 can output one or more of the customized audio signals 114, and the gaming system 102 can request feedback from the user based on their satisfaction with the customized audio signals 114. Based on receiving the feedback, the gaming system 102 can process feedback data 206 representing the user's feedback as part of the contextual data 110 using the machine learning model 202, and the gaming system 102 can update (e.g., regenerate) at least one of the one or more customized audio signals 114 accordingly. In this case, the gaming system 102 can request feedback from the user each time a new customized audio signal 114 is outputted by the gaming system 102, or periodically, such as once a month or once a season. In some examples, the gaming system 102 can update (e.g., fine-tune) one or more parameters of the model 202 based on the feedback data 206.

FIG. 3 is a flow diagram of an example process for generating the one or more customized audio signals by processing data. The process 300 can be executed, for example, by a system of one or more computers, located in one or more locations, and programmed appropriately in accordance with this specification. For example, a system, e.g., the system 102 of FIG. 1, appropriately programmed, can perform the process 300.

Operations of the process 300 include obtaining contextual data associated with a power-up process of a gaming system (302). The contextual data includes at least one of: time information or location information associated with the power-up process of the gaming system. For example, the time information can include a current time of day, a current time of year, or both. The location information can include a current season, a current location, current weather, or a combination thereof.

In some examples, the contextual data further includes user customization data. The user customization data can include historical user data, feedback data, the user preference data, or a combination thereof. For example, the historical user data includes information associated with media previously downloaded onto a user device of the gaming system, information associated with media previously loaded onto the gaming console of the gaming system, or both. For example, the media can be software (e.g., gaming software) or a video.

The feedback data can be an indication by the user of whether the user approves or disapproves of the one or more customized audio signals. In particular, the gaming system 102 can receive feedback data associated with the one or more customized audio signals, and the gaming system 102 can update the at least one of the one or more customized audio signals based on the feedback data

The user preference data can include a respective preferred time length of each of the one or more customized audio signals on the gaming system.

Operations of the process 300 also include generating, using a machine learning model, the one or more customized audio signals, the machine learning model trained to generate the one or more customized audio signals in accordance with one or more components of the contextual data (304). That is, the machine learning model can take as input the time information, the location information, the user customization data, or a combination thereof. The machine learning model can be trained to process each of the types of information to generate the one or more customized audio signals.

In some examples, the system can wrap at least one of the one or more customized audio signals with a particular standardized audio signal prior to the at least one customized audio signal, after the at least customized audio signal, or both. For example, the system can access a standardized audio signal (e.g., a known phonetic branding associated with the gaming console), and the system can generate customized audio signal such that the standardized audio signal wraps prior to the customized audio signal (e.g., plays before the customized audio signal), after the customized audio signal (e.g., plays after the customized audio signal), or both (plays before and after the customized audio signal).

Operations of the process 300 also include providing the one or more customized audio signals to at least one acoustic transducer associated with the gaming system to be outputted through at least one acoustic transducer (306). The gaming system 102 can output the one or more customized audio signals using an operating system of the gaming system.

In some examples, the gaming system 102 can store the one or more customized audio signals on a storage device associated with the gaming system such that the one or more customized audio signals are outputted through the at least one acoustic transducer during a subsequent power-up process. For example, the at least one acoustic transducer is disposed on a gaming console associated with the gaming system (e.g., an internal speaker). In another example, the at least one acoustic transducer is external to the gaming console (e.g., an external speaker).

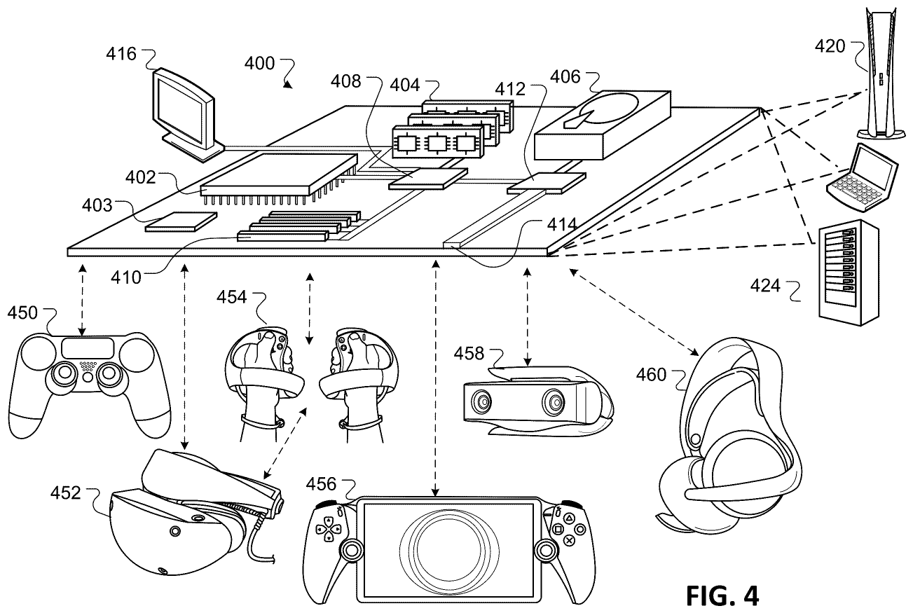

FIG. 4 shows an example of a computing device 400 and associated accessories that can be employed to execute implementations of the present disclosure. The computing device 400 is intended to represent various forms of gaming consoles such as PS5®, PS4®, PS3®, PS2® etc., desktops, workstations, personal digital assistants, servers, blade servers, mainframes, and other appropriate computers. The components shown here, their connections and relationships, and their functions, are meant to be examples only, and are not meant to be limiting. The computing device 400 can form at least a portion of a gaming system (e.g., the gaming system 100 described above with reference to FIG. 1) that can include one or more remote computing devices such as ones implementing a cloud-based portal or gaming platform.

In various implementations, the computing device 400 includes some combination of one or more processors or central processing units (CPUs) 402, one or more graphic processing units (GPUs) 403, memory 404, one or more storage devices 406, a high-speed interface 408, and/or a low-speed interface 412. In some implementations, the high-speed interface 408 connects to the memory 404 and multiple high-speed expansion ports 410. In some implementations, the low-speed interface 412 connects to a low-speed expansion port 414 and the storage device 406. In some implementations, the high-speed interface 408 connects to the storage device 406. Each of the processor 402, the GPU 403, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk. In some implementations, the memory 404 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 406 is capable of providing mass storage for the computing device 400. In some implementations, the storage device 406 may be or include a computer-readable medium, such as a hard disk device, an optical disk device, a flash memory, or other similar solid-state memory device, or an array of devices, including devices in a storage area network or other configurations. In some implementations, the storage device 406 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 406 can be configured to support expandable storage via compatible non-volatile memory express (NVMe) SSDs. Instructions can be stored in an information carrier, and when executed by one or more processing devices, such as processor 402, perform one or more methods, such as those described above. The instructions can also be stored by one or more storage devices, such as non-transitory computer-readable or machine-readable mediums, such as the memory 404, the storage device 406, or memory on the processor 402. The instructions can constitute software for providing interactive game play on a user interface such as a graphical user interface (GUI) presented on the display 416.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 450 such as a DualSense®, DualShock®, or Access™ controllers for PlayStation® devices, a virtual reality (VR) or augmented reality (AR) headset 452 such as the PS VR2 headset, accessory controllers 454 such as PS VR2 Sense™, a handheld gaming device 456 such as PlayStation Portal®, a camera 458, and/or an earphone/headphone set 460 such as the PULSE Elite™ headset or the Pulse Explore™ earbuds. In some implementations, the computing device 400 includes one or more acoustic transducers, and/or is connected to one or more external acoustic transducers such as one or more speakers associated with the display 416.

The computing device 400 may be implemented in a number of different forms, as shown in the FIG. 4. For example, the computing device 400 may be implemented as a gaming console 420, or as one or more servers 424 or as a rack within a server. In some implementations, the computing device 400 may be implemented as a personal computer such as a laptop computer 422. In some implementations, the computing device 400 can be implemented as a mobile device such as the connected handheld gaming device 456. In some implementations, a computing device can include one or more of the computing device 400, and an entire system may be made up of multiple computing devices communicating with each other. For example, a gaming system can include one or more of a gaming console 420, one or more accessories, and a remote platform such as a cloud-based platform implemented on one or more servers 424.

The processor 402 can be implemented as a chipset of chips that include separate and multiple analog and digital processors. For example, the processor 402 can be a multi-core processor that supports high-speed processing and enables complex computational tasks, real-time physics simulations, and advanced artificial intelligence (AI) capabilities. In one example, the processor 402 includes at least 8 cores, at least 16 threads, and operates at variable frequencies around 3.5 GHz or more. In some implementations, the processor 402 may be a Complex Instruction Set Computers (CISC) processor, a Reduced Instruction Set Computer (RISC) processor, or a Minimal Instruction Set Computer (MISC) processor.

In some implementations, the GPU 403 includes a custom GPU that supports an advanced architecture such as the RDNA 2 architecture developed by AMD. In one example, the GPU 403 includes at least 36 compute units running at speeds of 2 GHz or more, and delivers performance of at least 10 teraflops. The GPU 403 can be configured to support high quality graphics rendering. For example, the GPU 403 can be configured to support hardware-accelerated ray tracing for enhanced realism in lighting and reflections, thereby providing a highly immersive gaming experience.

The computing device can be configured to interact with one or more connected input/output or accessory device in providing the gaming experience. In some implementations, the computing device communicates with a handheld controller 450—e.g., a DualSense®, DualShock®, or Access™ controller for PlayStation® devices—to provide the gaming experience. In some implementations, the controller 450 features a high-fidelity haptic feedback system with one or more actuators that simulate a wide range of tactile sensations. In some implementations the controller 450 includes one or more adaptive triggers that adjust resistance based on in-game actions to provide for a realistic feel. The ergonomic design of the controller 450 can be configured to allow for comfortable use even in long gaming sessions. For example, the controller 450 can include textured grips and an optimized button layout. In some implementations, the controller 450 includes one or more of: integrated motion sensors, a high-resolution touchpad, and a built-in microphone array. The controller 450 includes an array of buttons, joysticks, and other controls that allow a user to interact with the computing device 400 to participate in interactive gameplay presented, for example, on a display device such as the display 416. The controller 450 can be powered by one or more regular or rechargeable batteries and supports both wireless and wired connectivity with the computing device 400, for example, via Bluetooth, WiFi, USB-C etc., or via a proprietary connection such as PlayStation Link™. In some implementations, the controller 450 includes a light bar and player indicators for visual feedback and customization.

In some implementations, the input/output or accessory device includes a VR/AR headset 452. One example of such a headset is the PlayStation VR2 (PS VR2) headset that is configured to provide an immersive and interactive gaming experience. In some implementations, the headset 452 features dual organic light emitting device (OLED) displays with a combined resolution of 4000×2080 pixels—thus providing sharp visuals and a wide field of view. In some implementations, the VR/AR headset 452 includes advanced eye-tracking technology that enables foveated rendering, optimizing performance by focusing on where the user is looking. In some implementations, the headset 452 includes integrated cameras that facilitate tracking head movements without external sensors. In some implementations, the headset includes haptic feedback for tactile sensations and/or one or more acoustic transducers configured to provide a spatial sound effect the user. The headset 452 can include an adjustable headband and cushioned padding, and can be configured to connect to the computing device 400 either over a wireless network (e.g., over a WiFi® or Bluetooth® connection, or a proprietary connection such as PlayStation Link™) or over a wire such as a USB-C cable.

In some implementations, the headset 452 can be configured to work in conjunction with one or more accessory controllers 454 such as the PlayStation VR2 Sense™ controllers. The accessory controllers 454 can be configured to enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 454 can be configured to provide a comfortable experience even during extended gameplay. In some implementations, the accessory controllers include one or more integrated sensors (accelerometer, gyroscope, etc.) and cameras to provide motion tracking. The accessory controllers 454 can be configured to connect to the computing device 400 and/or the headset 452 over a wireless connection such as WiFi® or Bluetooth®.

In some implementations, the computing device 400 can be connected to a handheld gaming device 456 such as the PlayStation Portal®. The handheld gaming device 456 can be configured to stream games and media from the computing device 400 via a wireless connection such as WiFi® or Bluetooth® . The handheld gaming device 456 includes a high-resolution screen that allows users to play games and/or stream media remotely without using the display 416 connected to the computing device 400. This allows the display to be used for other purposes while the computing device 400 facilitates gameplay on the handheld gaming device 456. In some implementations, the handheld gaming device 456 is configured to act as a streaming receiver without running games natively on the device 456 itself. This makes the handheld gaming device 456 a convenient option for playing games run on the computing device 400, while leaving a TV connected to the computing device 400 free to be used for viewing other media. The handheld gaming device 456 can includes buttons and features similar to (or even same as) the controller 450, thus providing for a similar gaming experience as that with the controller 450.

In some implementations, the input/output or accessory devices can include a camera 458 and/or an earphone/headphone set 460 such as the PULSE Elite™ headset or the Pulse Explore™ earbuds. The camera 458 can be used to track user-movements, which in turn can be used as an input to an interactive game being executed on the computing device 400. The earphone/headphone set 460 can be used to provide audio feedback/output to a user from the computing device 400. In some implementations, the earphone/headphone set 460 can include a microphone configured to receive spoken inputs/instructions that in turn can be used to control an interactive game being executed on the computing device 400.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. (“U.S. Patent for Parallel processing of reduction and broadcast . . . ”) In some cases, multitasking and parallel processing may be advantageous.

What is claimed is:

1. A method for generating one or more customized audio signals for a gaming system, the method comprising:
obtaining contextual data associated with a power-up process of the gaming system, the contextual data including at least one of: time information or location information associated with the power-up process of the gaming system;
generating, using a machine learning model, the one or more customized audio signals, the machine learning model trained to generate the one or more customized audio signals in accordance with one or more components of the contextual data; and
providing the one or more customized audio signals to at least one acoustic transducer associated with the gaming system to be outputted through the at least one acoustic transducer.

2. The method of claim 1, further comprising:
storing the one or more customized audio signals on a storage device associated with the gaming system such that the one or more customized audio signals are outputted through the at least one acoustic transducer during a subsequent power-up process.

3. The method of claim 2, wherein, the at least one acoustic transducer is disposed on a gaming console associated with the gaming system.

4. The method of claim 1, wherein the at least one acoustic transducer is external to a gaming console associated with the gaming system.

5. The method of claim 4, wherein outputting the one or more customized audio signals is facilitated by an operating system of the gaming system.

6. The method of claim 2, wherein generating, using the machine learning model, the one or more customized audio signals comprises:
receiving feedback data associated with the one or more customized audio signals; and
updating at least one of the one or more customized audio signals based on the feedback data.

7. The method of claim 1, wherein the time information comprises a current time of day, a current time of year, or both.

8. The method of claim 1, wherein the location information comprises a current season, a current location, current weather, or a combination thereof.

9. The method of claim 7, wherein the contextual data further comprises user customization information comprising historical user data, feedback data, user preference data, or a combination thereof.

10. The method of claim 9, wherein the historical user data comprises information associated with media previously downloaded onto a user device of the gaming system, information associated with media previously loaded onto a gaming console of the gaming system, or a combination thereof.

11. The method of claim 9, wherein the user preference data comprises a respective preferred time length of each of the one or more customized audio signals on the gaming system.

12. The method of claim 1, wherein generating, using the machine learning model, the one or more customized audio signals comprises:
wrapping at least one of the one or more customized audio signals with a particular standardized audio signal prior to the at least one customized audio signal, after the at least customized audio signal, or both.

13. A gaming system comprising:
a user device; and
one or more computers configured to interact with the user device and to perform operations comprising:
obtaining contextual data associated with a power-up process of the gaming system, the contextual data including at least one of: time information or location information associated with the power-up process of the gaming system;
generating, using a machine learning model, the one or more customized audio signals, the machine learning model trained to generate the one or more customized audio signals in accordance with one or more components of the contextual data; and
providing the one or more customized audio signals to at least one acoustic transducer associated with the gaming system to be outputted through the at least one acoustic transducer.

14. The gaming system of claim 13, the operations further comprising:
storing the one or more customized audio signals on a storage device associated with the gaming system such that the one or more customized audio signals are outputted through the at least one acoustic transducer during a subsequent power-up process.

15. The gaming system of claim 14, wherein, the at least one acoustic transducer is disposed on a gaming console associated with the gaming system.

16. The gaming system of claim 13, wherein the at least one acoustic transducer is external to a gaming console associated with the gaming system.

17. One or more non-transitory computer storage devices encoded with computer program instructions that when executed by one or more computers cause the one or more computers to perform operations comprising:
obtaining contextual data associated with a power-up process of a gaming system, the contextual data including at least one of: time information or location information associated with the power-up process of the gaming system;
generating, using a machine learning model, the one or more customized audio signals, the machine learning model trained to generate the one or more customized audio signals in accordance with one or more components of the contextual data; and
providing the one or more customized audio signals to at least one acoustic transducer associated with the gaming system to be outputted through the at least one acoustic transducer.

18. The one or more non-transitory computer storage devices of claim 17, the operations further comprising:
storing the one or more customized audio signals on a storage device associated with the gaming system such that the one or more customized audio signals are outputted through the at least one acoustic transducer during a subsequent power-up process.

19. The one or more non-transitory computer storage devices of claim 18, wherein, the at least one acoustic transducer is disposed on a gaming console associated with the gaming system.

20. The one or more non-transitory computer storage devices of claim 17, wherein the at least one acoustic transducer is external to a gaming console associated with the gaming system.
